(19) United States
(12) Patent Application Publication
(10) Pub. No.: US 2008/0026237 A1
(43) Pub. Date: Jan. 31, 2008

(54) MAT ACRYLIC RESIN FILM

(75) Inventors: Koji Koyama, Niihama-shi (JP); Noriko Tokumoto, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/831,056

(22) Filed: Jul. 31, 2007

(30) Foreign Application Priority Data
Jul. 31, 2006 (JP) P2006-207731

(51) Int. Cl. B32B 25/08

(52) U.S. Cl. 428/516

(57) ABSTRACT

A mat acrylic resin film having an acrylic resin film substrate made of a resin composition which contains an alkyl methacrylate polymer and acrylic rubber particles, and a mat layer formed on at least one surface of the film substrate from a coating composition containing an acrylic polymer and inorganic fine particles.

### FIELD OF THE INVENTION

The present invention relates to a mat acrylic resin film having a mat layer formed on the surface of an acrylic resin film. Furthermore, the present invention relates to a marking film comprising a mat acrylic resin film, and also to a multilayer film or sheet comprising a mat acrylic resin film laminated on other film or sheet as well as a laminate molded article comprising a mat acrylic resin film or a multilayer film or sheet integrally laminated on a molded article of a thermoplastic resin.

### BACKGROUND ART

Hitherto, a plastic plate such as an acrylic resin plate or a polycarbonate resin plate is usually used as a substrate which is matted or grained. For example, the surface of a substrate is matted or grained by thermoforming, and the substrate is used as a decorative molded article. In these years, as a method for producing such a highly decorative molded article, a film-lamination method such as a simultaneous injection molding-lamination method has been frequently employed, and a matted acrylic resin film has been increasingly desired.

The simultaneous injection molding-lamination method includes a method comprising the steps of inserting a resin film between male and female molds for injection molding, injecting a resin melt through one of the molds, and forming an injection molded article with simultaneously laminating the resin film on the molded article; and a method comprising the step of firstly preforming a resin film by, for example, vacuum molding, and then inserting the preformed resin film into an injection molding mold or firstly preforming a resin film by vacuum molding or pneumatic molding in an injection molding mold, and then injecting a resin melt in the mold to integrally mold the resin with the film. The latter method is known as an insert molding method.

As a mat acrylic resin film, a film produced by transferring a mat pattern to the surface of a film using a mold and a film produced by compounding a matting agent in a resin forming the film as known (see, for example, JP-A-10-237261) However, those films may have a drawback such that the mat appearance tends to disappear because of the stretching of the mat surface when the mat film is laminated on a substrate or when a substrate to which the mat film is laminated is thermoformed. To overcome such a drawback, JP-A-2003-211598 proposes the production of a mat acrylic resin film having, on its surface, a mat layer (a delustered layer) of a thermosetting resin or photosetting resin by compounding inorganic fine particles in the resin.

However, in the case of the mat acrylic rosin film proposed in JP-A-2003-211598, the mat layer tends to be cracked by the elongation of the resin film, and thus the appearance of the mat layer tends to deteriorate or the optical properties thereof tend to change.

### SUMMARY OF THE INVENTION

An object of the present invention is to provide a mat acrylic resin film having a mat layer which is hardly be cracked by the elongation of the resin film and maintains a good matting property.

Accordingly, the present invention provides a mat acrylic resin film comprising an acrylic resin film substrate made of a resin composition which comprises an alkyl methacrylate polymer and acrylic rubber particles, and a mat layer formed on at least one surface of the film substrate from a coating composition containing an acrylic polymer and inorganic fine particles.

In the mat acrylic resin film of the present invention, the mat layer may be formed on one surface of the film substrate, and images may be printed on the other surface of the film substrate to impart a decoration property to the mat film. In this case, when a pressure sensitive adhesive layer is formed on the surface having printed images, the film can be used as a marking film. Furthermore, a multilayer film or sheet can be provided when the mat layer of the mat acrylic resin film of the present invention is used as a front face and other film or sheet is laminated on the other surface. In addition, a laminate molded article having a good matting property is provided when the mat acrylic resin film or multilayer film or sheet according to the present invention is integrally laminated on a thermoplastic resin molded article while the mat layer is set as a front face.

The mat acrylic resin film of the present invention has a mat layer which is hardly cracked by elongation of the film substrate and maintains the good matting property. When the mat acrylic resin film of the present invention is used, a laminate molded article having the good matting property can be obtained. Furthermore, the mat acrylic resin film of the present invention can be preferably used for a multilayer film and a marking film.

### BRIEF DESCRIPTION OF DRAWING

FIG. 1 shows a schematic cross-sectional view showing one example of a layered structure of a mat acrylic resin film of the present invention.

### DETAILED DESCRIPTION OF THE INVENTION

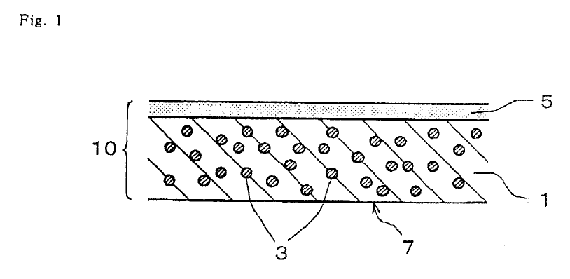

A typical example of a layer structure of the mat acrylic resin film of the present invention is shown in FIG. 1. In the present invention, a mat layer 5 is formed on at least one surface of an acrylic resin film substrate 1 to give a mat acrylic resin film 10. The film substrate 1 is made of a resin composition comprising a matrix resin mixed with acrylic rubber particles 3, while the mat layer 5 is formed from a coating composition containing an acrylic polymer and inorganic fine particles. FIG. 1 shows an example of the mat layer 5 formed on one surface of the film substrate 1, although the mat layers 5 may be formed on both surfaces of the film substrate 1.

The film substrate 1 is made of a resin composition containing a matrix resin mixed with acrylic rubber particles 3. The matrix resin is a polymer comprising an alkyl methacrylate as a primary monomer. Specific examples of the polymer to be used as the matrix resin of the film substrate include alkyl methacrylate homopolymers, i.e., polymers consisting essentially of an alkyl methacrylate, and copolymers of an alkyl methacrylate and at least one monomer copolymerizable with the alkyl methacrylate such as an acrylic acid ester. The alkyl methacrylate preferably has 1 to 4 carbon atoms in the alkyl group. In particular, methyl methacrylate is preferable. In the case of a copolymer of an alkyl methacrylate and an acrylic acid ester, specific examples of the acrylic acid ester are alkyl acrylates having preferably 1 to 10 carbon atoms in their alkyl groups. Specific examples of the alkyl acrylates include methyl acrylate, ethyl acrylate, propyl acrylate, isopropyl acrylate, butyl acrylate, isobutyl acrylate, hexyl acrylate, octyl acrylate, 2-ethylhexyl acrylate, etc.

In the case of a copolymer of an alkyl methacrylate and an alkyl acrylate, it is preferable to copolymerize 50 to 99.5% by weight of the alkyl methacrylate and 0.5 to 50% by weight of the alkyl acrylate. Furthermore, other monomer may be used as a copolymerizable component in an amount such that the effects of the present invention are not impaired.

These alkyl methacrylate polymers preferably have a glass transition temperature of 60 to 110° C. and a weight average molecular weight of 70,000 to 600,000. The glass transition temperature is more preferably 75° C. or higher and 105° C. or lower. The weight average molecular weight is more preferably 120,000 or higher and 300,000 or lower. The glass transition temperature can be measured with a differential scanning calorimeter in a nitrogen atmosphere at a heating rate of 10° C./min. The weight average molecular weight can be measured by gel permeation chromatography (GPC).

If the glass transition temperature is too low, the desirable surface hardness may not be attained. If the weight average molecular weight is too low, the melt viscosity of the polymer becomes so low to deteriorate the molding processibility of the resin and also deteriorate the processibility in the course of the simultaneous injection molding-lamination method. Accordingly, the precise thickness of the film or the surface matting property may not be obtained. When the weight average molecular weight is too high, the melt viscosity of the polymer becomes so high to deteriorate the processibility for forming a film and also gel-like materials are generated in the obtained film to cause some problems. In general, an acrylic resin has a glass transition temperature of from 30 to 110° C. Thus, according to the present invention, one having a glass transition temperature of from 60 to 110° C. is selected properly for use. Since the glass transition temperature of the acrylic resin is substantially determined in accordance with the composition of monomers composing the resin, the monomer composition may be adjusted so as to control the glass transition temperature within the above-mentioned range.

As the alkyl methacrylate polymer, polymers as-produced may be used, or a mixture of two or more polymers having different weight average molecular weights may be used. In particular, when it is desired to increase the surface hardness of the film, a mixture containing at least one polymer component having a weight average molecular weight of 70,000 to 200,000 may be used. Furthermore, when it is desired to improve both the surface hardness and the moldability for preventing unevenness at the time of thermoforming after the film formation, it is advantageous to use a mixture containing at least one polymer having a weight average molecular weight of 70,000 to 200,000 and at least one polymer having a weight average molecular weight of 150,000 to 700,000. The chart of the weight average molecular weight distribution of such a mixture shows a peak spreading towards a bottom or a peak having a shoulder. The polymer having a weight average molecular weight of 70,000 to 200,000 usually has a glass transition temperature of from 90 to 110° C., and the polymer having a weight average molecular weight of 150,000 to 700,000 usually has a glass transition temperature of from 40 to 80° C.

In the present invention, acrylic rubber particles 3 are compounded in the polymer comprising the alkyl methacrylate, and the polymer composition is used to form the film substrate 1. The acrylic rubber particles used herein may be those containing a rubber elastic material prepared by copolymerizing an alkyl acrylate having 4 to 8 carbon atoms in the alkyl group, a polyfunctional monomer and optionally a monofunctional monomer. In addition to the acrylic rubber particles having a monolayer structure of such a copolymer, acrylic rubber particles having a multilayer structure comprising at least one layer of such a copolymer may be used. The polyfunctional monomer may be a compound having at least two polymerizable carbon-carbon double bonds in one molecule and examples thereof include alkenyl esters of unsaturated carboxylic acids such as allyl (meth)acrylate and methallyl (meth)acrylate; dialkenyl esters of dibasic acids such as diallyl maleate; and unsaturated carboxylic acid diesters of glycols such as alkylene glycol di(meth)acrylate. Examples of the optional monofunctional monomers are styrene, nuclear alkyl-substituted styrene, α-methylstyrene, acrylonitrile, etc.

Each particle of the acrylic rubber particles, which have a multilayer structure containing the rubber elastic material and are prepared by the copolymorization of a monomer mixture containing an alkyl acrylate and a polyfunctional monomer, may contain a layer of a rubber elastic material of the copolymer of the alkyl acrylate and the polyfunctional monomer and a layer of a hard polymer of comprising methyl methacrylate around the layer of the rubber elastic material, and may have two, three or more layers. Acrylic rubber particles having a two-layer structure may include those each having, as an inner layer, a rubber elastic material prepared by the copolymerization of a monomer mixture containing the alkyl acrylate and the polyfunctional monomer, and as an outer layer, a hard polymer comprising methyl methacrylate. Acrylic rubber particles having a three-layer structure may include those each having, as an innermost layer, a hard polymer comprising methyl methacrylate; as a middle layer, a rubber elastic material prepared by the copolymerization of a monomer mixture containing the alkyl acrylate and the polyfunctional monomer; and as an outer layer, a hard polymer comprising methyl methacrylate. The innermost layer is preferably crosslinked by using a small amount of a polyfunctional monomer besides methyl methacrylate. Such acrylic rubber particles having a three-layer structure can be produced by a method described in U.S. Pat. No. 3,793,402, the disclosure of which is hereby incorporated by reference (corresponding to JP-B-55-27576). In the present invention, rubber particles having a multilayer structure of at least two layers are preferably used. More preferably, rubber particles having a three-layer structure is used from the viewpoint of the improvement of the surface hardness of a film.

The average particle size of the acrylic rubber particles is usually from 50 to 500 nm, preferably at least 80 nm, and more preferably at least 150 nm. It is preferably 350 nm or less and more preferably 300 nm or less. When the average particle size is too small, the impact resistance of a film to be obtained tends to deteriorate. When it is too large, the transparency of the film tends to decrease.

With respect to the acrylic rubber particles each consisting of a hard polymer comprising methyl methacrylate as the outermost layer and a rubber elastic material surrounded by the hard polymer, the outermost layer of the acrylic rubber particles is compatible with the matrix acrylic resin when the acrylic rubber particles are mixed with the matrix resin. Thus, when the rubber component is dyed with ruthenium oxide on the cross-section surface of the mixture and observed by an electron microscope, the rubber particles are observed as if the outermost layer were eliminated. In concrete, in the case of using acrylic rubber particles having a two-layer structure consisting of the inner layer of the rubber elastic material and the outer layer of the hard polymer comprising methyl methacrylate, the rubber elastic material portions are dyed and observed as if the particles have a single layer structure. In the case of using acrylic rubber particles having a three-layer structure consisting of the innermost layer of the hard polymer comprising methyl methacrylate, the middle layer of the rubber elastic material, and the outermost layer of the hard polymer comprising methyl methacrylate, the center parts of the particles, which constitute the innermost layers, are not dyed and only the rubber elastic material portions are dyed and observed as if the particles have a two-layer structure. Herein, the average diameter of the rubber particles means an average value of the diameters of the portions dyed when the rubber particles are mixed with the matrix resin and the cross-section surface of the mixture is dyed with ruthenium oxide and observed as a substantially circular shape.

In the present invention, the acrylic resin film used as the substrate is made of a resin composition containing the polymer comprising the alkyl methacrylate and the acrylic rubber particles in a weight ratio of 95:5 to 40:60 (the polymer to the acrylic rubber particles). When the amount of the acrylic rubber particles is too low, it becomes difficult to form a film from the resin composition. When it is too high, the surface hardness of the film unpreferably deceases. The amount of the acrylic rubber particles is preferable at least about 10 parts by weight per 100 parts by weight of the polymer comprising the alkyl methacrylate and the particles. More preferably, the amount of the acrylic rubber particles is at least 15 parts by weight in view of the effective prevention of the film breakage during a printing process or the simultaneous molding-lamination process. Furthermore, the resin composition of the film substrate may contain other polymer component in an mount that the effects of the present invention are not impaired.

The acrylic resin film used as the substrate may contain common additives. Examples of the additives include weathering agents (e.g. hindered phenol type antioxidants, phosphorus type antioxidants, sulfur type antioxidants, ultraviolet ray absorbers and hindered amine type photostabilizers), flame retardants, coloring agents, pigments, inorganic fillers, etc. These additives maybe added at the time of kneading the polymer comprising the alkyl methacrylate and the acrylic rubber particles, or may be compounded in the polymer comprising the alkyl methacrylate and/or the acrylic rubber particles.

In particular, the addition of an ultraviolet ray absorber is preferable, since a laminate molded article with further improved weather resistance can be obtained. As the ultraviolet ray absorber, those commonly added to an acrylic resin such as benzotriazole type ultraviolet ray absorbers and benzophenone type ultraviolet ray absorbers may be used singly or as a mixture of two or more of them.

Specific examples of the benzotriazole type ultraviolet ray absorbers include: 2,2′-methylenebis[6-(2H-benzotriazol-2-yl)-4-(1,1,3,3-tetramethylbutyl)phenol], 2-(2-hydroxy-5-methylphenyl)-2H-benzotriazole, 2-[2-hydroxy-3,5-bis(α,α-dimethylbenzyl)-phenyl]-2H-benzotriazole, 2-(3,5-di-tert-butyl-2-hydroxy-phenyl)-2H-benzotriazole, 2-(3-tert-butyl-2-hydroxy-5-methylphenyl)-5-chloro-2H-benzotriazole, 2-(3,5-di-tert-butyl-2-hydroxyphenyl)-5-chloro-2H-benzotriazole, 2-(3,5-di-tert-amyl-2-hydroxyphenyl)-2H-benzotriazole, 2-(2-hydroxy-5-tert-octylphenyl)-2H-benzotriazole, 2-[2-hydroxy-3-(3,4,5,6-tetrahydrophthal-imidomethyl)-5-methylphenyl]-2H-benzotriazole, etc. Specific examples of the benzophenone type ultraviolet ray absorbers include: 2-hydroxy-4-methoxybenzophenone, 2-hydroxy-4-octoxybenzophenone, 2,4-dihydroxybenzophenone, 2-hydroxy-4-methoxy-4′-chlorobenzophenone, 2,2′-dihydroxy-4-methoxybenzophenone, 2,2′-dihydroxy-4,4′-dimethoxybenzophenone, etc. Among them, benzotriazole type ultraviolet ray absorbers with high molecular weights, for example, 2,2′-methylenebis[6-(2H-benzotriazol-2-yl)-4-(1,1,3,3-tetramethylbutyl)phenol] are preferable, from the viewpoint of the decrease of the volatile components liberated from the film and the prevention of deterioration of printed images.

The polymer comprising methyl methacrylate, the acrylic rubber particles and optional additives are kneaded and formed into a film by extrusion casting with chili rolls or inflation extrusion molding. From the viewpoint of the printability and thickness accuracy, it is preferable to employ the extrusion molding method for forming the film by bringing both surfaces of the film into contact with roll surfaces, or a belt cooling extrusion method for forming the film by bringing both surfaces into contact with metal belts.

The film obtained in such a manner has sufficient flexibility, surface hardness, and thickness accuracy. A mat acrylic resin film 10 can be produced by using the acrylic resin film as the film substrate 1 and forming the mat layer 5 of a coating composition containing the acrylic polymer and the inorganic fine particles on at least one surface of the substrate film 1.

The acrylic polymer, which is one of the essential components of the coating composition for forming the mat layer 5, is a polymer comprising an acrylic monomer such as an (meth)acrylic acid ester, (meth)acrylonitrile, (meth)acrylic acid and (meth)acrylamide, and preferably an alkyl methacrylate. Similarly to the polymer as the matrix resin for the film substrate 1 described above, the polymer comprising the alkyl methacrylate may be a homopolymer essentially consisting the alkyl methacrylate or a copolymer of the alkyl methacrylate and other monomer copolymerizable with the alkyl methacrylate. The alkyl methacrylate preferably has 1 to 12 carbon atoms, more preferably 1 to 4 carbon atoms, in the alkyl group. Examples of the other monomer copolymerizable with the alkyl methacrylate include acrylic monomers other than alkyl methacrylate such as methacrylic acid esters other than the alkyl methacrylate, acrylic acid esters, (meth)acrylonitrile, (meth)acrylic acid, and (meth)acrylamide; and styrenic monomers such as styrene, nuclear-alkyl-substituted styrenes, and α-methylstyrene.

From the viewpoint of heat resistance and coatability, the acrylic polymer preferably has a weight average molecular weight of 10,000 to 200,000, more preferably 50,000 to 150,000. From the viewpoint of heat resistance, the polymer preferably has a glass transition temperature of 50 to 120° C., more preferably 80 to 105° C.

The inorganic fine particles, which are the other essential component for the coating composition for forming the mat layer 5, may be particles of oxides such as silica, alumina and titanium oxide, mica, calcium carbonate, and magnesium carbonate. Among them, oxides are preferably used, and silica is particularly preferably used. To obtain desirable mat feel, the inorganic fine particles preferably have a particle size of 1 to 10 μm, more preferably 3 to 5 μm. The inorganic fine particles may be surface treated.

The amounts of the acrylic polymer and the inorganic fine particles in the coating composition are preferably 40 to 99 parts by weight of the acrylic polymer and 1 to 60 parts by weight of the inorganic fine particles based on 100 parts by weight of the both components in total. In accordance with the required optical properties, the amount of the inorganic fine particles may be selected. If the amount of the inorganic fine particles is too large, the adhesion property of the mat layer 5 to the film substrate 1 is lowered.

A solvent may be added to the coating composition to adjust the viscosity of the composition and the thickness of the mat layer 5. Examples of the solvent include aromatic compounds such as toluene and xylene; ketones such as methyl ethyl ketone, methyl isobutyl ketone and cyclohexanone; esters such as ethyl acetate and butyl acetate; and the like. Furthermore, additives such as antisettling agents, stabilizers, antioxidants, and coloring agents may optionally be added to the coating composition. The addition of a coloring agent imparts decoration properties to the mat layer 5 by coloration. The coating composition is preferably prepared by adding the inorganic fine particles to a solution obtained by dissolving the acrylic polymer in a solvent and dispersing the inorganic fine particles by a bead mill such as a sand mill for making the particle size uniform. The inorganic fine particles are preferably dispersed in a concentration of about 1 to 15% by weight in the coating composition.

The mat layer 5 is formed by applying the coating composition to the surface of the film substrate 1 on which the mat layer is to be formed. The application may be carried out by various known methods such as die coating, gravure coating, roll coating, blade coating, dip coating and flow coating. The formed coating film can be converted into the mat layer 5 by drying to evaporate the solvent when the coating composition contains the solvent.

The thickness of the mat layer 5 is generally about 2 to 20 μm. The mat layer 5 preferably has a ten point average surface roughness Rz in a range of 1 to 10 μm from the viewpoint of the retention of decoration properties and a sufficient matting property. The surface roughness may be adjusted in the above range depending on the final use of the mat film. The ten point average surface roughness is measured according to JIS B0601. If the ten point average surface roughness Rz of the mat layer is too low, the matting property cannot be sufficiently attained. If Rz is too high, the surface roughness gives coarse impression in the case of visual observation and the decoration properties may be deteriorated.

The mat acrylic resin film 10 preferably has a whole thickness of about 40 to 800 μm. When the mat layer 5 is formed only on one surface of the mat film 10, images may be printed on the other surface of the mat film 10, or the film substrate 1 itself may be colored, to impart the decoration properties. When the mat layers 5 are formed on the both surfaces of the mat film 10, the film substrate 1 may also be colored to impart the decoration properties. Since the mat acrylic resin film 10 has excellent molding properties, the film is desirable from the viewpoint of the retention of the matting property during molding and can be employed in a surface coating method such as a simultaneous injection molding-lamination method.

Furthermore, the mat acrylic resin film 10 may have a pressure sensitive adhesive layer or an adhesive layer on one surface thereof. Such a layer can be easily formed by coating a pressure sensitive adhesive or an adhesive to the target surface. When the mat layer 5 is formed on one surface of the film substrate 1, the pressure sensitive adhesive layer or the adhesive layer may be formed on the surface on the side of the mat layer 5 or the pressure sensitive adhesive layer or the adhesive layer may be formed on the other surface which is an undelustered smooth surface 7. When the mat layer 5 is formed on one surface, the pressure sensitive adhesive layer or the adhesive layer is usually formed on the other surface 7.

In the case of a film having the mat layer 5 only on one surface, when the images are printed on the other surface 7 having no mat layer, the printing is carried out by gravure printing, screen printing or ink-jet printing using an ink jet printer by computer graphic technique, by making best use of the characteristic that the surface 7 is smooth. When the printing is carried out on the smooth surface 7 having no mat layer, a pressure sensitive adhesive layer may be formed on the printed layer to give a film used as a marking film.

The marking film means a film on which images such as various kinds of letters, patterns, signs and photographs are printed and which is adhered to the surfaces of various constructions. The marking film may be used for advertisements, propagandas, warnings and displays and thus usable for, for example, outdoor advertisement boards, guiding signs (e.g. signs in stations), markings for various kinds of vehicles such as passenger vehicles, commercial vehicles, buses, railway cars (electric cars and commuter cars), markings for automatic venders, markings for wooden walls of plants and construction sites, markings of shutters and outer walls, markings of construction machinery, markings of ships, and decorative displays for in-line parts of passenger vehicles, commercial vehicles, bicycles and light electrical elements. While flexible vinyl chloride resin films, polyurethane resin films and polyethylene terephthalate films have been conventionally used as the marking films, the mat acrylic resin film of the present invention is excellent in weather resistance and light fastness as compared with the conventional marking films.

The mat film of the present invention can be used in the form of a multilayer film or sheet by laminating the mat film on other film or sheet so that the mat layer 5 forms the front face of the laminate film or sheet. When the mat layer 5 is formed on one surface of the film substrate 1, the other film or sheet may be laminated on the surface 7 of the mat film reverse to the mat layer 5. When the mat layers 5 are formed on both surfaces of the film substrate 1, the other film or sheet may be laminated on one surface. Examples of the resin composing the other film or sheet include acrylic resins, flexible vinyl chloride resins, polyurethane resins, polyester resins such as polyethylene terephthalate, and polyolefin resins. The images may be printed on the surface of the other film or sheet. In the case of a multilayer film or sheet, for example, a so-called lamination method such as a method comprising forming a thermoplastic resin in the form of a film or a sheet and then laminating the obtained film or sheet and the mat film of the present invention using heat rolls, a method comprising thermally bonding the other film or sheet and the mat film of the present invention with a press, or a (wet lamination) method comprising inserting an adhesive layer between the other film or sheet and the mat film of the present invention, can be employed.

Such a multilayer film may also be used as a marking film by forming a pressure sensitive adhesive layer on the surface reverse to the surface having the mat film. When the multilayer film is used as the marking film, the mat layer 5 is formed on one surface of the film substrate 1 to give a mat film 10 of the present invention and then the images may be printed on the surface 7 reverse to the mat layer 5, or the images may be printed on the other film to be adhered to the mat film 10, or the images may be printed on the surface reverse to the surface of the other film to which the mat film 10 is to be adhered.

Furthermore, the mat film, the mat film having the mat layer on one surface and printed images on the other surface, or the multilayer film or sheet comprising the mat film laminated on the other film or sheet in such a manner that the mat layer is set to be the front face according to the present invention may be integrally laminated on the surface of a thermoplastic resin molded article by, for example, a simultaneous injection molding-lamination method. In any case, lamination is carried out in a manner that the mat layer of the mat film is set in the outermost side. Examples of the thermoplastic resin suitable for laminating the mat film or multilayer film or sheet having the mat film of the present invention include polyolefin type resins, vinyl chloride resins, acrylonitrile-butadiene-styrene copolymers (ABS resin), polyurethane resins and acrylic resins.

As described above, the simultaneous injection molding-lamination method includes a method comprising the steps of inserting a resin film between male and female molds for injection molding, injecting a resin melt through one of the molds, and forming an injection molded article with simultaneously laminating the resin film on the molded article; and a method comprising the step of firstly pre-forming a resin film by, for example, vacuum molding, and then inserting the preformed resin film into an injection molding mold or firstly preforming a resin film by vacuum molding or pneumatic molding in an injection molding mold, and then injecting a resin melt in the mold to integrally mold the resin with the film. The latter method is known as an insert molding method. The details of the simultaneous injection molding-lamination method are found in JP-B-63-6339, JP-B-04-9647 and JP-A-7-9484.

Hereinafter, the present invention will be described more in detail with reference to Examples, which do not limit the scope of the present invention in any way. In the Examples, “parts” are by weight unless otherwise specified.

### EXAMPLE 1

Production of Acrylic Resin Film

As an alkyl methacrylate polymer, an acrylic resin produced by a bulk polymerization method, containing 99% by weight of methyl methacrylate units and 1% by weight of methyl acrylate units, having a glass transition temperature of 105° C. and a weight average molecular weight of 140,000 was used. A glass transition temperature was an extrapolated glass transition starting temperature measured at a heating rate of 10° C./minute by differential scanning calorimetry according to JIS K7121. The weight average molecular weight was measured by GPC in conditions of using three columns arranged in series: TSKgel GMH_{HR}-H (7.8 mmφ×300 mm) (manufactured by Tosoh Corporation); a solvent: tetrahydrofuran; a temperature: 40° C.; a detector: RI; and a flow rate: 1.0 ml/minute, and using the standard PMMA samples as molecular weight standards.

As the acrylic rubber particles, were used those produced according to Example 3 of U.S. Pat. No. 3,793,402 the disclosure of which is hereby incorporated by reference (corresponding to JP-B-55-27576) and having a spherical three-layer structure consisting of a hard polymer obtained by polymerization of methyl methacrylate and a small amount of allyl methacrylate as an innermost layer, an elastic polymer obtained by polymerization of butyl acrylate as a primary component, styrene and a small amount of allyl methacrylate as a middle layer, and a hard polymer obtained by polymerization of methyl methacrylate and a small amount of ethyl acrylate as an outermost layer and having an average particle size of 210 nm when being mixed with a matrix resin.

As an ultraviolet absorber, 2,2′-methylene-bis[6-(2H-benzotriazol-2-yl)-4-(1,1,3,3-tetramethylbutyl)phenol] (ADK STAB LA-31, manufactured by ADEKA CORPORATION) was used.

Eighty (80) parts of the acrylic resin, 20 parts of the rubber particles, and 0.5 part of the ultraviolet absorber were mixed with a tumbler mixer and melted and kneaded with a unidirectional rotation type twin screw extruder while keeping the temperature of the resin at 255° C. to obtain pellets. Next, the pellets of each acrylic resin composition were extruded through T type film dies (lip clearance: 0.5 mm, 600 mm width, and set temperature: 250° C.) using a single screw extruder (barrel diameter 65 mmΦ: manufactured by Toshiba Machine Co., Ltd.) while bringing both surfaces of a film in complete contact with cooling polishing rolls to obtain a 125 μm-thick acrylic resin film.

Formation of Mat Layer

A coating composition (1) with an acrylic polymer concentration of 20% was prepared by mixing 100 parts of a solution containing an acrylic polymer having a weight average molecular weight of 91,000 and a number average molecular weight of 83,000 (Acrybase LH 101D manufactured by Fujikura Kasei Co., Ltd.; glass transition temperature: 105° C.; acid value: 1.66), 20 parts of ethyl acetate, 10 parts of xylene, 50 parts of methyl ethyl ketone, and 35 parts of toluene. Separately, a coating composition (2) with an acrylic polymer concentration of 20% and a silica concentration of 5% was prepared by mixing 100 parts of the same solution of the acrylic polymer as used in the preparation of the coating composition (1), 20 parts of silica fine particles (OK-412 manufactured by Degussa, average particle size: 3.0 μm) and 20 parts of ethyl acetate and dispersing the mixture by a sand mill, then adding and mixing a mixed solution containing 1 part of an antisettling agent (Disparlon 6900 manufactured by Kusumoto Chemicals, Ltd.) and 5 parts of xylene while stirring; and further adding and mixing 20 parts of methyl ethyl ketone and 35 parts by toluene. The weight average molecular weight and the number average molecular weight of the above acrylic polymer were measured by GPC in conditions of using four columns arranged in series: TSKgel GMH_{HR}-H (7.8 mmφ×300 mm): manufactured by Tosoh Corporation; a solvent: tetrahydrofuran; at a temperature: 40° C.; a detector: RI; and a flow rate: 0.5 ml/minute and using standard PMMA samples as molecular weight standards.

The coating compositions (1) and (2) were mixed at a weight ratio of 1:1 and the coating composition mixture was applied to one surface of the acrylic resin film produced in the above step with a bar coater #12 and then dried by keeping the resulting acrylic resin film in an oven at 60° C. for 20 minutes. Accordingly, a mat acrylic resin film having a mat layer having a thickness of 5 μm on one surface was obtained.

Evaluation

The mat acrylic resin film obtained in the previous steps was subjected to a tensile test at an elongation of 20%, 50%, 80% and 100% at 150° C. (width: 50 mm, initial chuck interval: 80 mm, and pulling rate: 100 mm/minute) and cooled to room temperature while maintaining the stress as it was, and then the stress was released. A haze defined in JIS K7136, a 60-degree mirror surface gloss defined in JIS K7105, and a ten point average surface roughness defined in JIS B0601 were measured. The results are shown in Table 1 together with their percentage changes. Furthermore, the mat surface was observed with eyes after the test and evaluated according to the following 3-grade valuation standard.
A: No minute crack observed.
B: A few minute cracks observed.
C: A large number of minute cracks observed.

### COMPARATIVE EXAMPLE 1

A mat acrylic resin film was produced in the same manner as Example 1 except that a dispersion obtained by dispersing silica fine particles in a solution containing a urethane acrylate type thermosetting resin was used as a coating composition. The evaluation results are shown in Table 1.

TABLE 1

| | | | | | | | | Ten point average | | | |
|---|---|---|---|---|---|---|---|---|---|---|---|
| | | Haze (%) | | | 60% Surface gloss | | | surface roughness (μm) | | | |
| | Elongation | Before | After | | Before | After | | Before | After | | Visual |
| | (%) | test | test | Difference | test | test | Difference | test | test | Difference | observation |
| Ex. 1 | 20 | 44.1 | 35.6 | −8.5 | 26.9 | 27.5 | +0.6 | 3.6 | 3.0 | −0.6 | A |
| | 50 | 43.4 | 41.1 | −2.3 | 27.5 | 23.8 | −3.8 | 3.6 | 3.4 | −0.2 | A |
| | 80 | 43.8 | 45.6 | +1.8 | 27.4 | 21.7 | −5.7 | 3.3 | 3.6 | +0.4 | A |
| | 100 | 43.7 | 50.0 | +6.3 | 27.4 | 18.8 | −8.6 | 3.2 | 3.7 | +0.5 | A |
| Comp. | 20 | 45.8 | 68.1 | +22.3 | 26.5 | 10.4 | −16.1 | 3.9 | 4.1 | +0.2 | B |
| Ex. 1 | 50 | 46.0 | 75.7 | +39.8 | 25.9 | 8.3 | −17.7 | 3.9 | 8.6 | +4.7 | B |
| | 80 | 46.0 | 75.7 | +29.8 | 25.7 | 8.5 | −17.2 | 4.4 | 11.8 | +7.4 | C |
| | 100 | 45.5 | 76.6 | +31.1 | 26.4 | 8.8 | −17.6 | 4.1 | 14.3 | +10.2 | C |

When the mat acrylic resin film obtained in Example 1 was employed in the simultaneous injection molding-lamination method for an ABS resin so that the mat surface was set to be the front face side, the obtained laminate molded article had an excellent mat property and gave deep impression.

What is claimed is:

1. A mat acrylic resin film comprising an acrylic resin film substrate made of a resin composition which comprises an alkyl methacrylate polymer and acrylic rubber particles, and a mat layer formed on at least one surface of the film substrate from a coating composition containing an acrylic polymer and inorganic fine particles.

2. The mat acrylic resin film according to claim 1, wherein the alkyl methacrylate polymer is selected from the group consisting of alkyl methacrylate homopolymers and alkyl methacrylate-alkyl acrylate copolymers.

3. The mat acrylic resin film according to claim 1, wherein the alkyl methacrylate polymer has a glass transition temperature of 60 to 110° C. and a weight average molecular weight of 70,000 to 600,000.

4. The mat acrylic resin film according claim 1, wherein the acrylic rubber particles have a multilayer structure comprising a layer of a rubber elastic material containing a copolymer of a C₄-C₈-alkyl acrylate and a polyfunctional monomer and a layer of a methyl methacrylate hard polymer which is formed around the layer of the rubber elastic material.

5. The mat acrylic resin film according to claim 1, wherein the acrylic rubber particles have an average particle size of 50 to 500 nm.

6. The mat acrylic resin film according to claim 1, wherein the acrylic polymer is a polymer comprising a C₁-C₁₂-alkyl methacrylate.

7. The mat acrylic resin film according to claim wherein the acrylic polymer has a weight average molecular weight of 10,000 to 200,000.

8. The mat acrylic resin film according to claim 1, wherein the inorganic fine particles are silica particles.

9. The mat acrylic resin film according to claim 1, which has a total thickness of 50 to 500 μm.

10. The mat acrylic resin film according to any one of claim 1, wherein the mat layer is formed on one surface of the acrylic resin film substrate and images are printed on the other surface.

11. A marking film comprising a mat acrylic resin film according to claim 10 and a layer of a pressure sensitive adhesive layer formed on the surface of the mat acrylic resin film on which the images are printed.

12. A multilayer film or sheet comprising a mat acrylic resin film according to any one of claims 1 to 10 with setting the mat layer thereof to be a front face, and other film or sheet laminated on the other surface of the mat acrylic resin film having no mat layer.

13. A laminate molded article comprising a thermoplastic resin molded article and a mat acrylic resin film according to any one of claims 1 to 10 or a multilayer film or sheet according to 12 which is integrally laminated on the thermoplastic resin molded article while setting the mat layer to be the front face.
